(19) United States
(12) Patent Application Publication
(10) Pub. No.: US 2016/0071342 A1
(43) Pub. Date: Mar. 10, 2016

(54) ZONE-BASED USER VERIFICATION SERVER, SYSTEM, AND METHOD THEREOF

(71) Applicant: Electronics and Telecommunications Research Institute, Daejeon (KR)

(72) Inventors: Soo Hyung KIM, Daejeon (KR); Seok Hyun KIM, Daejeon (KR); Seung Hyun KIM, Daejeon (KR); Jong Hyouk NOH, Daejeon (KR); Sang Rae CHO, Daejeon (KR); Young Seob CHO, Daejeon (KR); Jin Man CHO, Daejeon (KR); Seung Hun JIN, Daejeon (KR); Dae Seon CHOI, Daejeon (KR)

(21) Appl. No.: 14/699,328

(22) Filed: Apr. 29, 2015

(30) Foreign Application Priority Data
Sep. 4, 2014 (KR) 10-2014-0117686

(51) Int. Cl. G07C 9/00

(52) U.S. Cl. CPC G07C 9/00111; G07C 9/00103

(57) ABSTRACT

Provided are a zone-based user verification system, a method thereof, and a zone-based user verification server. The zone-based user verification system includes a verification zone setting device configured to set a user verification zone and transmit user verification zone information to a user terminal located near the set user verification zone, a user terminal configured to determine whether the user terminal has entered the user verification zone by using the user verification zone information, and transmit identification information for user verification when it is determined that the user terminal has entered the user verification zone, a service terminal configured to transmit a user verification request signal when it is determined that the user terminal has entered the user verification zone, and a user verification server configured to perform user verification by using information included in the user verification request signal received from the service terminal and identification information for user verification received from the user terminal.

### CROSS-REFERENCE TO RELATED APPLICATIONS

This application claims the benefit of and priority under 35 U.S.C. §119 to Korean Patent Application No. 10-2014-0117686, filed on Sep. 4, 2014, the disclosure of which is incorporated herein by reference in its entirety.

### TECHNICAL FIELD

The present invention relates to a user verification system, and more particularly, to a zone-based user verification system for verifying a user using information obtained from the user when the user enters a zone in which a user needs to be verified, such as a security zone, and providing the verification result to a manager or the user, and a method thereof.

### BACKGROUND

Services provided in factories, offices, stores, and the like, as well as security areas such as power plants, military areas, or government organizations need user verification as to whether a user, who requests a service, is an authenticated user.

Related art user verification methods include a method of proposing a physical confirmation medium owned by a user or a method of inputting information known by only a user.

For example, a card including user identification information may be used in order for a user to be provided with a payment service, a card including a radio frequency (RF) tag is recognized to allow a user to enter an area providing a service only to a designated user, or a password may be input to log into a personal computer (PC) in an office.

However, the related art user verification method requires a behavior of using the user's hand repeatedly whenever a service is provided, causing user inconvenience and making it difficult to provide a seamless service.

Also, if a user holds things, or the like, so he or she is not free from using his or her hands, the user should put things down or should stop what he or she was doing to perform a user verification procedure.

In order to solve the foregoing problems, a user verification technique using an RFID tag, allowing for automatically verifying a user even at a distance away from a terminal providing a service by a few meters, has been developed. However, the technique of verifying a user using an RFID tag should provide RFID tags to users and a situation in which a provided RFID tag is lost needs to be handled.

In addition, related art user verification methods mentioned above have difficulty in identifying users when several normal users are present in a zone in which user verification is required. Thus, it is difficult to apply the related art user verification methods to a service in which users are to be identified.

### SUMMARY

Accordingly, the present invention provides a zone-based user verification system for verifying a user without a behavior of using a user's hand and identifying users when multiple users are present in a user verification zone.

In one general aspect, a zone-based user verification system includes: a verification zone setting device configured to set a user verification zone and transmit user verification zone information to a user terminal located near the set user verification zone; a user terminal configured to determine whether the user terminal has entered the user verification zone by using the user verification zone information, and transmit identification information for user verification when it is determined that the user terminal has entered the user verification zone; a service terminal configured to transmit a user verification request signal when it is determined that the user terminal has entered the user verification zone; and a user verification server configured to perform user verification by using information included in the user verification request signal received from the service terminal and identification information for user verification received from the user terminal.

In another general aspect, a zone-based user verification method includes: setting a user verification zone; transmitting user verification zone information to a user terminal located near the user verification zone; when it is determined that the user terminal has entered the user verification zone, obtaining identification information for user verification from the user terminal; performing user verification by comparing the identification information for user verification obtained from the user terminal and previously stored user information; and transmitting a performed user verification result.

In another general aspect, a zone-based user verification server includes: an information receiving module configured to receive identification information for user verification from a user terminal located within a user verification zone, and receive a signal requesting user verification of the user terminal from a service terminal communicating with the user terminal; a user verification module configured to perform user verification by using the identification information for user verification received from a user terminal and information related to the user terminal included in the signal requesting user verification received from the service terminal; and a verification result transmitting module configured to transmit the performed user verification result to the user terminal or the service terminal.

Other features and aspects will be apparent from the following detailed description, the drawings, and the claims.

### BRIEF DESCRIPTION OF THE DRAWINGS

FIG. 1 is a block diagram illustrating a configuration of a zone-based user verification system according to an embodiment of the present invention.

FIGS. 2A and 2B are views illustrating an example of setting a user verification zone by a verification zone setting device of the zone-based user verification system according to an embodiment of the present invention.

FIGS. 3A, 3B, and 3C are views illustrating an example of zones that can be set as a user verification zone according to an embodiment of the present invention.

FIG. 4 is a view illustrating an example of outputting a user verification result by the zone-based user verification system according to an embodiment of the present invention.

FIG. 5 is a flow chart illustrating a process of a zone-based user verification method according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Hereinafter, embodiments of the present invention will be described in detail with reference to the accompanying drawings.

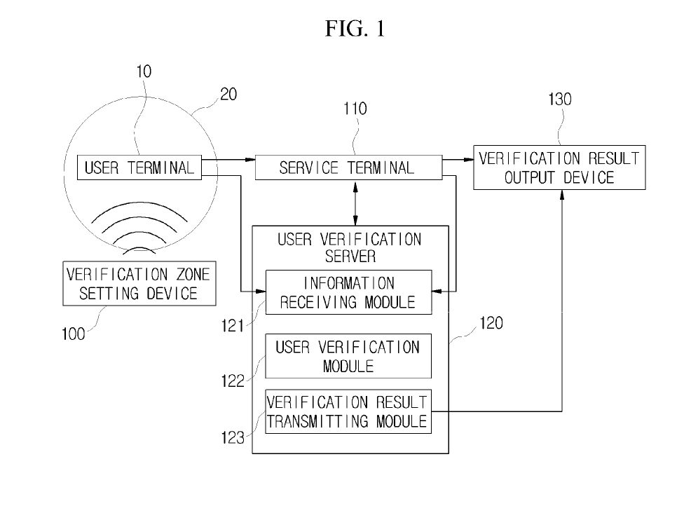

FIG. 1 is a block diagram illustrating a configuration of a zone-based user verification system according to an embodiment of the present invention.

As illustrated in FIG. 1, the zone-based user verification system according to an embodiment of the present invention includes a user terminal 10, a zone-based user verification system according to an embodiment of the present invention includes a user terminal 10, a verification zone setting device 100, a service terminal 110, a user verification server 120, and a verification result output device 130.

The verification zone setting device 100 sets a user verification zone 20 for determining entry of the user terminal 10 and transmits user verification zone information to the user terminal 10 located in the vicinity of the set user verification zone 20.

Here, the user verification zone information is information indicating characteristics of the user verification zone 20, including at least one among identification information of the user verification zone 20, location characteristics information of the user verification zone 20, disposition form information of different verification zone setting devices setting the user verification zone 20, signal transmission characteristics information of the verification zone setting devices, and distance information between the verification zone setting devices.

Here, the verification zone setting device 100 may transmit user verification zone information to the user terminal 10 located in the vicinity of the user verification zone 20 using a wireless communication scheme. For example, a format of the user verification zone information transmitted by the verification zone setting device 100 may be a Bluetooth™ message format.

Also, the verification zone setting device 100 may transmit the user verification zone information having transmission strength differently set according to characteristics of information included in the user verification zone information, to the user terminal 100.

A plurality of verification zone setting devices 100 may be installed in the same user verification zone 20, and accordingly, the plurality of verification zone setting devices 100 may transmit user verification zone information to the user terminal 10.

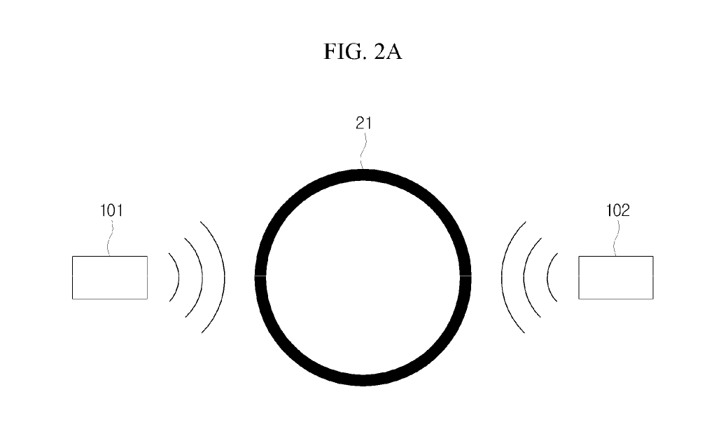

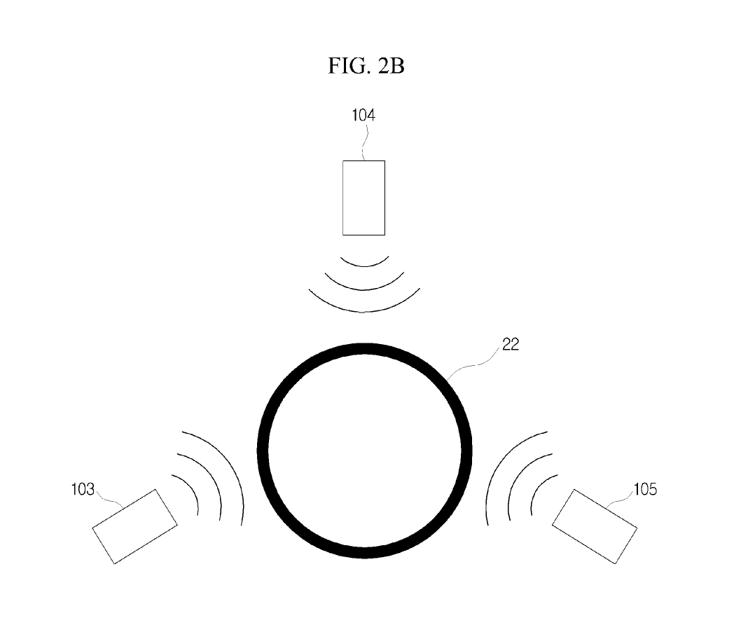

Hereinafter, an example in which the verification zone setting device 100 sets the user verification zone 20 will be described in detail with reference to FIGS. 2A and 2B.

FIGS. 2A and 2B are views illustrating an example of setting the user verification zone 20 by the verification zone setting device 100 of the zone-based user verification system according to an embodiment of the present invention.

As illustrated in FIG. 2A, a user verification zone 21 is set by verification zone setting devices 101 and 102 according to disposition forms, signal arrival distances, and the like, of the verification zone setting devices 101 and 102.

Also, as illustrated in FIG. 2B, a user verification zone 22 may be set by three or more verification zone setting devices 103, 104, and 105 according to accuracy of required information.

In this manner, the verification zone setting devices 101, 102, 103, 104, and 105 setting the user verification zones 21 and 22 transmit, to the user terminal 10 located in the vicinity of the user verification zones 21 and 22, user verification zone information including at least one among identification information of the user verification zones 21 and 22, location characteristics information of the user verification zones 21 and 22, disposition form information of the different verification zone setting devices 101, 102, 103, 104, and 105 setting the user verification zones 21 and 22, signal transmission characteristics information (signal transmission strength information) of the verification zone setting devices 101, 102, 103, 104, and 105, and distance information between the verification zone setting devices 101, 102, 103, 104, and 105.

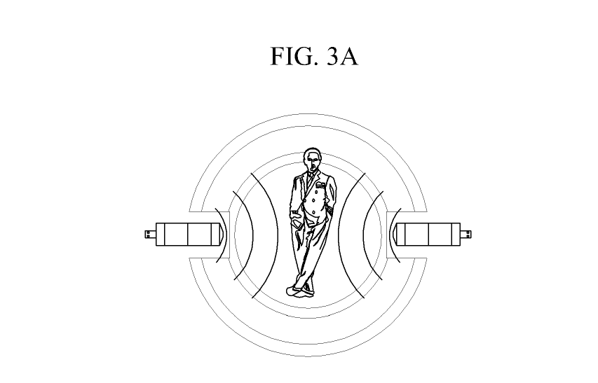

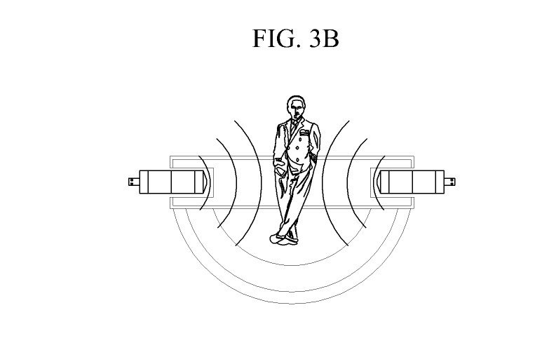

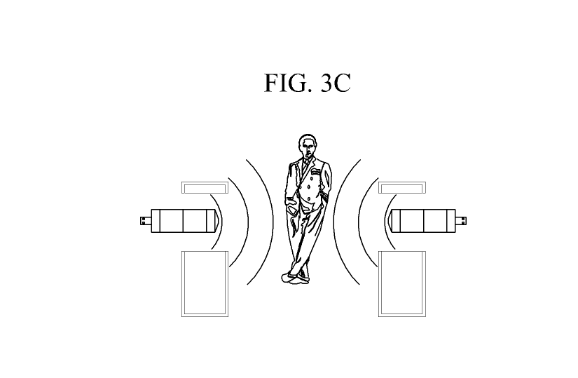

FIGS. 3A, 3B, and 3C are views illustrating an example of zones that can be set as the user verification zone 20 according to an embodiment of the present invention.

As illustrated in FIG. 3A, the verification zone setting device 100 may be disposed near a circular table and set a zone including the circular table, as a user verification zone 20.

Alternatively, as illustrated in FIG. 3B, the verification zone setting device 100 may be disposed on a wall surface and set a zone in front of the wall surface, as a user verification zone 20.

Alternatively, as illustrated in FIG. 3C, the verification zone setting device 100 may be disposed in a gate and set a gate passage zone as a user verification zone 20.

The verification zone setting device 100 according to another embodiment of the present invention may transmit, to the user terminal 10 located near the user verification zone 20, information (for example, the information set to be different according to the circular table, the wall surface, and the gate) indicating characteristics of a location in which the verification zone setting device 100 is disposed, such that the user terminal 10 may easily determine whether the user terminal 10 has entered the user verification zone 20.

When the verification zone setting device 100 according to another embodiment of the present invention is available for communicating with a particular device connected to the user terminal 10, the verification zone setting device 100 may transmit user verification zone information to the user terminal 10.

The verification zone setting device 100 according to another embodiment of the present invention may check a list of the user verification zone 20 registered in the user terminal 10 in advance and transmit user verification zone information to the user terminal 10 which has entered the registered user verification zone 20.

In this manner, when the verification zone setting device 100 is available for communicating with a particular device connected to the user terminal 10, or when the user terminal 10 enters the previously registered user verification zone 20, the verification zone setting device 100 transmits user verification zone information to the user terminal 10, having advantages in that power of a battery consumed for the user terminal 10 to receive information may be saved.

When it is determined that the user terminal 10 has entered the user verification zone 20 set by the verification zone setting device 100, the service terminal 100 requests user verification from the user verification server 120.

In detail, when the service terminal 110 receives information related to entry into the user verification zone 20 from the user terminal which has determined to entry into the user verification zone 20, the service terminal 110 transmits a user verification request signal requesting user verification to the user verification server 120.

Here, the user terminal 10 determines whether the user terminal 10 has entered the user verification zone 20 by using at least one among identification information of the user verification zone 20, location characteristics information of the user verification zone 20, disposition form information of different verification zone setting devices setting the user verification zone 20, signal transmission characteristics information of the verification zone setting devices, and distance information between the verification zone setting devices.

Also, the user terminal 10 determine whether it has entered the user verification zone 20 by measuring acceleration, vibration, and a slope of the user terminal 10 using a gyro sensor included in the user terminal 10 and comparing the measured value with user verification zone information received from the verification zone setting device 100.

When the user terminal 10 determines that it has entered the user verification zone 20, the user terminal 10 transmits information related to entry into the user verification zone 20, such as information randomly generated in relation to the user verification zone 20 or information used to generate identification information for user verification, to the service terminal 110.

Also, the user terminal 10 transmits, to the user verification server 120, identification information for user verification including at least one among user identification (ID) information previously shared with the user verification server 120, information generated with a user verification key previously shared with the user verification server 120, the user verification zone information, a time at which the user terminal 10 has entered the user verification zone 20, and information received from the service terminal 110.

The service terminal 110 transmits, to the user verification server 120, a user verification request signal including at least one among information received from the user terminal 10, identification information of the service terminal 110, a key previously stored in the service terminal 110 by the user verification server 120, and information transmitted in voice by the user.

Here, the service terminal 110 transmits the user verification request signal to the user verification server 120, when transmission of information related to the user terminal 10 is requested by the user verification server 120, when a device (for example, a button, a keyboard, a mouse, a monitor, a camera, and the like) connected to the service terminal 110 instructs transmission of information related to the user terminal 10, or when information related to the entry into the user verification zone 200 is received from the user terminal 10.

Also, if the user verification zone 20 includes a first user verification zone and a second user verification zone within the first user verification zone, when it is determined that the user terminal 10 has entered the first user verification zone, the service terminal 110 communicates with the user verification server 120 and receives a user verification result of the user terminal. The service terminal 110 may discriminately provide a service to the user terminal 10 which has entered the second user verification zone, among a plurality of user terminals which have entered the first user verification zone, by using information specifying the user terminal received from the user terminal and a user verification result received from the user verification server 120.

For example, when a user who owns the user terminal (for example, a handsfree) checks in the entrance (first user verification zone) of a store, user information is transmitted to a point of sales (POS) (service terminal) of the store. When the user stands in or passes by a payment zone (second user verification zone) for payment, user information regarding the corresponding client is output on a POS screen. Here, the user terminal may transmit the user information to the user verification server, and the user verification server may provide a hi-pass payment type service providing a payment service through a simple verification procedure.

The user verification server 120 includes an information receiving module 121, a user verification module 122, and a verification result transmitting module 123.

The information receiving module 121 receives identification information for user verification from the user terminal 10 which has entered the user verification zone 20, and receives a user verification request signal from the service terminal 110.

In detail, the information receiving module 121 receives identification information for user verification including at least one among a user identification (ID) previously shared with the user verification server 120, information generated by a user verification key previously shared with the user verification server 120, user verification zone information, a time at which the user terminal 10 has entered the user verification zone 20, and information received from the service terminal 110.

The information receiving module 121 receives a user verification request signal including at least one among information received from the user terminal 10, identification information of the service terminal 110, a key previously stored in the service terminal 110 by the user verification server 120, and information transmitted in voice by the user.

When the user verification request signal is received, the user verification module 122 performs user verification using the information received from the user terminal 10 and the service terminal 110.

In detail, the user verification module 122 performs user verification by comparing the identification information for user verification received from the user terminal 10 and the information included in the user verification request signal received from the service terminal 110.

For example, the user verification module 122 may perform user verification by checking stored user-related information on the basis of the information received from the user terminal 10 and the service terminal 110 or may perform user verification by comparing a time at which the information related to the user terminal 10 was received from the service terminal 110 and the time at which the information related to the user terminal 10 was received from the user terminal 10.

In another example, the user verification module 122 may perform user verification by comparing the time at which the user verification request signal was received from the service terminal 110 and the time at which the identification information for user verification received from the user terminal 10 was generated.

In another example, the user verification module 122 may perform user verification by receiving one-time identification information of the user received by the service terminal 110 from the user terminal 10, from the service terminal 110, receiving one-time identification information of the user from the user terminal 10, and mapping identification information.

In another example, the user verification module 122 may perform user verification by determining whether a location of the service terminal 110 and a location of the user terminal 10 are close.

In another example, the user verification module 122 may perform user verification by using at least one among user identification (ID) previously shared with the user terminal 10, information generated with a user verification key previously shared with the user terminal 10, user verification zone information, a time at which the user terminal 10 has entered the user verification zone 20, and information received from the service terminal 110.

When identification information for user verification is received from a plurality of user terminals 10, the user verification module 122 generates user terminal identification information by using at least one among the identification information provided by the user terminal 10 through the service terminal 110, information previously shared with the user terminal 10, and information previously shared with the user of the user terminal 10, and transmits the same to the service terminal 110. The service terminal 110 identifies the plurality of user terminals 10 by using the user terminal identification information provided from the user verification module 122.

The verification result transmitting module 123 transmits the user verification result performed in the user verification module 122 to the user terminal 10 or the service terminal 110.

The verification result transmitting module 123 according to another embodiment of the present invention may be connected to the service terminal 110 and transmit the user verification result the verification result output device 130 connected to the service terminal 110 or separately installed to allow the user or a manager of the user verification zone 20 to check it, or to a wearable device (for example, a smart watch, a smart glass, a smart band, and the like) connected to the user terminal 10.

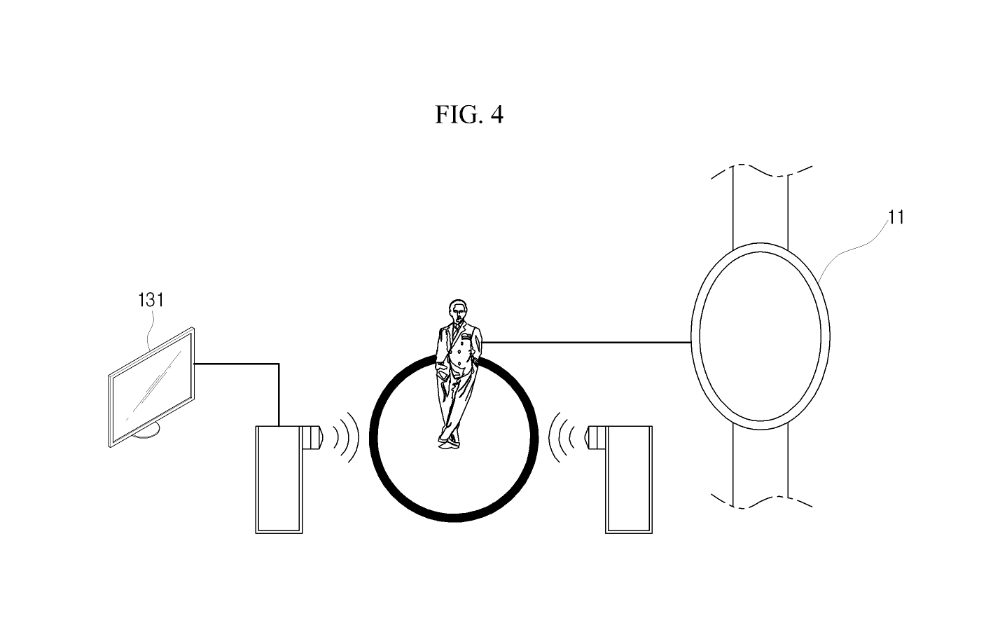

Hereinafter, an example of outputting a user verification result will be described in detail with reference to FIG. 4.

FIG. 4 is a view illustrating an example of outputting a user verification result by the zone-based user verification system according to an embodiment of the present invention.

As illustrated in FIG. 4, verification result output devices 131 and 11 outputting the user verification result are devices outputting a picture, a character, light, a sound, or vibrations to allow the user to explicitly determine whether the user terminal has entered the user verification zone 20.

Here, information output as a picture, a character, light, a sound, or vibrations may be user-related information registered in the user verification server 120, and may be output through an output device such that the user may check that he or she has been specified at the point in time at which the user terminal 10 transmitted the identification information for user verification to the user verification server 120 or at the point in time at which the service terminal 110 transmitted the user verification request signal.

Before outputting the user verification result, the verification result output devices 130 and 11 may output pictures or character strings registered or randomly selected by the user, and when the user selects a picture or a character string, the verification result output devices 130 and 11 may output the user verification result.

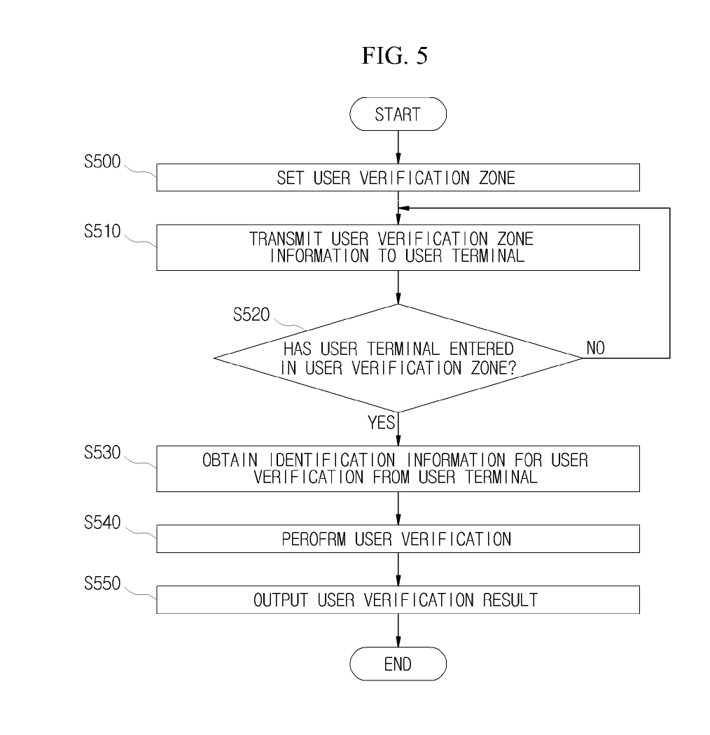

FIG. 5 is a flow chart illustrating a process of a zone-based user verification method according to an embodiment of the present invention.

A user verification zone for determining whether a user terminal has entered is set in step S500, and user verification zone information is transmitted to a user terminal located in the set user verification zone in step S510.

Here, the user verification zone is set by a plurality of verification zone setting devices according to a disposition form, a signal arrival distance, and the like, of the verification zone setting devices disposed on a circular table, a wall surface, a gate, and the like.

The user verification zone information is information indicating characteristics of the user verification zone, including at least one among identification information of the user verification zone, location characteristics information of the user verification zone, disposition form information of different verification zone setting devices setting the user verification zone, signal transmission characteristics information of the verification zone setting devices, and distance information between the verification zone setting devices.

When it is determined that the user terminal has entered the user verification zone in step S520, identification information for user verification is obtained from the user terminal in step S530.

Here, regarding whether the user terminal has entered the user verification zone, when the user terminal determines that it has entered the user verification zone by using the user verification zone information transmitted from the verification zone setting device, whether the user terminal has entered the user verification zone may be determined upon receiving the determination result from the user terminal.

Identification information for user verification may include at least one among user identification (ID) information previously shared with the user verification server, information generated using a user verification key previously shared with the user verification server, information related to a user verification zone, a time at which the user terminal has entered the user verification zone, and information received by the user terminal from the service terminal.

When the identification information for user verification is obtained from the user terminal, previously stored information related to the user of the user terminal is checked using the obtained identification information for user verification to verify the user who entered the user verification zone in step S540.

Here, the information related to the user of the user terminal is information received from the service terminal and stored and includes at least one among information received by the service terminal from the user terminal, identification information of the service terminal, a key previously stored in the service terminal by the user verification server, and information transmitted in voice by the user.

When the identification information for user verification is received from a plurality of user terminals, user terminal identification information is generated by using at least one among the identification information provided by the user terminal through the service terminal, information previously shared with the user terminal, and information previously shared with the user of the user terminal, and transmitted to the service terminal. The service terminal identifies the plurality of user terminals by using the provided user terminal identification information.

Alternatively, specific information generated to identify a user may be transmitted to the service terminal, and an operator (or the user) of the service terminal may check the corresponding specific information through an output device such as a display device to verify that the user has been specified, or conversely, specific information generated to identify a user may be received from the service terminal and a plurality of user terminals may be identified.

When the process of verifying the user is terminated, the user verification result is transmitted to the user terminal or the service terminal in step S550. In another example, the user verification result may be output through a wearable device connected to the user terminal and a display device connected to the service terminal, or the user verification result may be output by using an image, a character, light, a sound, vibrations, and the like, through a separately installed verification result output device.

According to the present invention, there is no need to supply a separate verification unit for user verification, and a user may be verified without a behavior of using the user's hand, reducing a time required for the verification procedure. Also, since a plurality of users present in a user verification zone may be identified, and thus, a user provided with a service may be recognized.

The present invention provides a zone-based user verification system performing a process of verifying a user of a user terminal which has entered a user verification zone only by transmitting and receiving information, without a behavior of requesting it from the user. A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A zone-based user verification system comprising:
a verification zone setting device configured to set a user verification zone and transmit user verification zone information to a user terminal located near the set user verification zone;
a user terminal configured to determine whether the user terminal has entered the user verification zone by using the user verification zone information, and transmit identification information for user verification when it is determined that the user terminal has entered the user verification zone;
a service terminal configured to transmit a user verification request signal when it is determined that the user terminal has entered the user verification zone; and
a user verification server configured to perform user verification by using information included in the user verification request signal received from the service terminal and identification information for user verification received from the user terminal.

2. The zone-based user verification system of claim 1, wherein the user verification server performs user verification by comparing a time at which the user verification request signal was received and a time at which the identification information for user verification was generated.

3. The zone-based user verification system of claim 1, wherein the user verification server performs user verification by determining whether a location of the service terminal and a location of the user terminal are close.

4. The zone-based user verification system of claim 1, wherein the user verification server performs user verification by using information including at least one among user identification (ID) previously shared with the user terminal, information generated with a user verification key previously shared with the user terminal, the user verification zone information, information of a time at which the user terminal entered the user verification zone, and information received from the service terminal.

5. The zone-based user verification system of claim 1, wherein the user verification server performs user verification by determining whether a previously registered wearable device is connected to the user terminal.

6. The zone-based user verification system of claim 1, wherein when identification information for user verification is received from a plurality of user terminals,
the user verification server provides user terminal identification information generated by using at least one among identification information provided by the user terminal through the service terminal, information previously shared with the user terminal, and information previously shared with a user of the user terminal, and
the service terminal identifies the plurality of user terminals using the user terminal identification information provided from the user verification server.

7. The zone-based user verification system of claim 1, wherein the service terminal transmits, to the user verification server, the user verification request signal including at least one among information received from the user terminal, identification information of the service terminal, a key previously stored in the service terminal by the user verification server, and information transmitted in voice by the user.

8. The zone-based user verification system of claim 1, wherein the service terminal transmits the user verification request signal to the user verification server, when transmission of information related to the user terminal is requested by the user verification server, when a device connected to the service terminal instructs transmission of information related to the user terminal, or when a signal indicating that the user terminal has entered the user verification zone is received from the user terminal.

9. The zone-based user verification system of claim 1, wherein if the user verification zone includes a first user verification zone and a second user verification zone within the first user verification zone, when it is determined that the user terminal has entered the first user verification zone, the service terminal communicates with the user verification server and receives a user verification result of the user terminal, and
the service terminal specifies a user terminal which has entered the second user verification zone by using information specifying the user terminal received from the user terminal, among a plurality of user terminals which have entered the first user verification zone, and the user verification result.

10. The zone-based user verification system of claim 1, wherein the verification zone setting device transmits, to the user terminal, the user verification zone information including at least one among identification information of the user verification zone, location characteristics information of the user verification zone, disposition form information of different verification zone setting devices setting the user verification zone, signal transmission characteristics information of the verification zone setting devices, and distance information between the verification zone setting devices.

11. The zone-based user verification system of claim 1, further comprising: a verification result output device connected to the service terminal and configured to output the user verification result received by the service terminal from the user verification server.

12. A zone-based user verification method comprising:
setting a user verification zone;
transmitting user verification zone information to a user terminal located near the user verification zone;
when it is determined that the user terminal has entered the user verification zone, obtaining identification information for user verification from the user terminal;
performing user verification by comparing the identification information for user verification obtained from the user terminal and previously stored user information; and
transmitting a performed user verification result.

13. The zone-based user verification method of claim 12, wherein the performing of user verification includes checking information related to a user of the user terminal by using identification information for user verification obtained from the user terminal.

14. The zone-based user verification method of claim 12, wherein the transmitting of user verification zone information includes transmitting the user verification zone information with transmission strength set to be different according to characteristics of information included in the user verification zone information.

15. The zone-based user verification method of claim 12, wherein the performing of user verification includes performing user verification by enabling the user terminal to determine whether a location of the service terminal and a location of the user terminal are close to each other, or performing user verification through a wearable device connected to the user terminal.

16. A zone-based user verification server comprising:
an information receiving module configured to receive identification information for user verification from a user terminal located within a user verification zone, and receive a signal requesting user verification of the user terminal from a service terminal communicating with the user terminal;
a user verification module configured to perform user verification by using the identification information for user verification received from a user terminal and information related to the user terminal included in the signal requesting user verification received from the service terminal; and
a verification result transmitting module configured to transmit the performed user verification result to the user terminal or the service terminal.

17. The zone-based user verification server of claim 16, wherein when identification information for user verification is received from a plurality of user terminals, the user verification module provides user terminal identification information generated by using at least one among identification information provided by the user terminal through the service terminal, information previously shared with the user terminal, and information previously shared with a user of the user terminal.

18. The zone-based user verification server of claim 16, wherein the user verification module performs user verification by comparing a time at which the information related to the user terminal was received from the service terminal and a time at which the identification information for user verification was generated from the user terminal.

19. The zone-based user verification server of claim 16, wherein the information receiving module receives, from the service terminal, information related to the user terminal including at least one among information received from the user terminal, identification information of the service terminal, a key previously stored in the service terminal by the user verification server, and information transmitted in voice by the user.

20. The zone-based user verification server of claim 16, wherein the information receiving module receives, from the user terminal, identification information for user verification including at least one among user identification (ID) previously shared with the user terminal, information generated with a user verification key previously shared with the user terminal, the user verification zone information, a time at which the user terminal entered the user verification zone, and information received from the service terminal.
